(19) United States
(12) Patent Application Publication
(10) Pub. No.: US 2009/0257859 A1
(43) Pub. Date: Oct. 15, 2009

(54) Vehicle tire loading device

(75) Inventor: Tae-Yong Kim, Gyeonggi-do (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/290,264

(22) Filed: Oct. 29, 2008

(30) Foreign Application Priority Data
Apr. 14, 2008 (KR) 10-2008-0034381

(51) Int. Cl. B65G 61/00

(52) U.S. Cl. 414/749.6

(57) ABSTRACT

The present invention relates to a loading device for a tire of a vehicle that facilitates installation of the tire in a tire assembly processes as a consequence of supplying the tire to a mounting position of the tire in a vehicle body. A loading device for a tire of a vehicle according to an exemplary embodiment of the present invention, which transfers the tire supplied by a traverse to a mounting position of the tire at a vehicle body in a tire assembly process, may include: at least one rail frame fixedly mounted at an upper portion of a workplace corresponding to a position of the vehicle body by a supporter and having a rail formed at a lower surface thereof; a transfer unit including a moving frame that is movably mounted on the rail frame by roller means and a first operating cylinder, a post mounted downward on the moving frame in a vertical direction, and a moving beam inserted in the post and being configured to move upwardly and downwardly by a vertical transfer unit; and a tire basket movably mounted on a lower end of the moving beam by a horizontal transfer unit, and receiving the tire supplied by the traverse.

### CROSS-REFERENCE TO RELATED APPLICATION

This application claims priority to and the benefit of Korean Patent Application No. 10-2008-0034381 filed on Apr. 14, 2008, the entire contents of which are incorporated herein by reference.

### BACKGROUND

(a) Technical Field

The present invention relates to a vehicle tire loading device. More particularly, the present invention relates to a vehicle tire loading device that can mount a tire on a vehicle body in a tire assembly process in a simpler manner.

(b) Related Art

Vehicle makers manufacture vehicles through various process lines from selection of materials to mass production of vehicles, and are making efforts to develop automated processes to manufacture more vehicles in a shorter time.

One of the automated processes is a tire assembling process. Conventionally, tires are transferred to respective mounting positions in a vehicle body by a conveyor and a tire loading device and workers then assemble the tires to the vehicle body.

As shown in FIG. 1, in a conventional tire loading device 100, an upper plate 105 is movably mounted by a roller unit 103 on a rail 101 that is mounted at an upper portion of a workplace, and a vertical frame 107 is rotatably mounted downwardly at a middle portion of the upper plate 105.

A loader frame 109 is mounted at a lower portion of the vertical frame 107. The loader frame 109 is connected to a front end of an operating rod 113 of an operating cylinder 111 that is mounted downwardly at one side of the vertical frame 107 such that the loader frame 109 is pivotable on the vertical frame 107 by a reciprocating operation of the operating cylinder 113. One end of a connecting frame 115 is rotatably mounted at one end of the loader frame 109, and a tire basket 117 is rotatably mounted at the other end of the connecting frame 115.

That is, when a tire that is transferred by a tire conveyor arrives in the tire basket 117 of the tire loading device 100, a worker move the tire loading device 100 on the rail 101 in order to place the tire at a position corresponding to a mounting position of the tire in the vehicle body, and rotate the tire basket 117 by means of the connecting frame 115.

After that, the tire is mounted at the vehicle body by minute adjusting processes where the loader frame 109 is moved downwardly or upwardly by the operating cylinder 111 such that the tire is placed to the mounting position of the tire. The tire mounting process is finished by moving the tire basket 117 downwardly for receiving the tire.

According to the conventional tire loading device, since workers must move the upper frame to the mounting position of the tire in the vehicle body, and adjust a position of the tire basket by adjusting the height of the loader frame, working efficiency is low. In addition, since workers must bend down in order to place the tire to the mounting position of the tire in the vehicle body, work-related musculoskeletal problems may occur.

The above information disclosed in this Background section is only for enhancement of understanding of the background of the invention and therefore it may contain information that does not form the prior art that is already known in this country to a person of ordinary skill in the art.

### SUMMARY

A loading device for a tire of a vehicle according to an exemplary embodiment of the present invention, which transfers the tire supplied by a traverse to a mounting position of the tire at a vehicle body in a tire assembly process, may include: at least one rail frame fixedly mounted at an upper portion of a workplace corresponding to a position of the vehicle body by a supporter and having a rail formed at a lower surface thereof; a transfer unit including a moving frame that is movably mounted on the rail frame by roller means and a first operating cylinder, a post mounted downward on the moving frame in a vertical direction, a moving beam inserted in the post and being configured to move upwardly and downwardly by a vertical transfer unit; and a tire basket that is movably mounted on a lower end of the moving beam by a horizontal transfer unit, and receiving the tire supplied by the traverse.

A pair of rail frames may be provided, wherein the first operating cylinder is mounted between the pair of rail frames and is connected to one end of the moving frame.

The post may have a hollow cross-section and have two ends, wherein the two ends of the post are open such that the moving beam is protruded upwardly or downwardly from the post when the moving beam is inserted therein and moves along the post.

Guide rollers may be mounted at both sides of upper and lower ends of the post such that the guide rollers guide the moving beam when the moving beam moves upwardly and downwardly.

The post may be supported on the moving frame by being supported by a support rod that has one end fixed to each lower edge portion of the moving frame and the other end fixed to each corner portion of the post.

The vertical transfer unit may include a second operating cylinder mounted downward at one side of the post and having an operating rod, a front end thereof being connected to one end of the moving beam.

The horizontal transfer unit may include: a mounting plate mounted on a lower end of the moving beam; a third operating cylinder mounted at one side of the mounting plate and having an operating rod, a front end of the operating rod being connected to one side of the tire basket by means of a mounting bracket; and a guide loader mounted corresponding to the third operating cylinder so as to be slid on the other side of the mounting plate by a mounting block, and having one end connected to the mounting bracket.

A stopper may be mounted on the other end of the guide loader such that the stopper abuts the mounting block and the guide loader is not separated from the mounting plate.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

FIG. 1 is a schematic diagram showing a vehicle tire loading device according to conventional art.

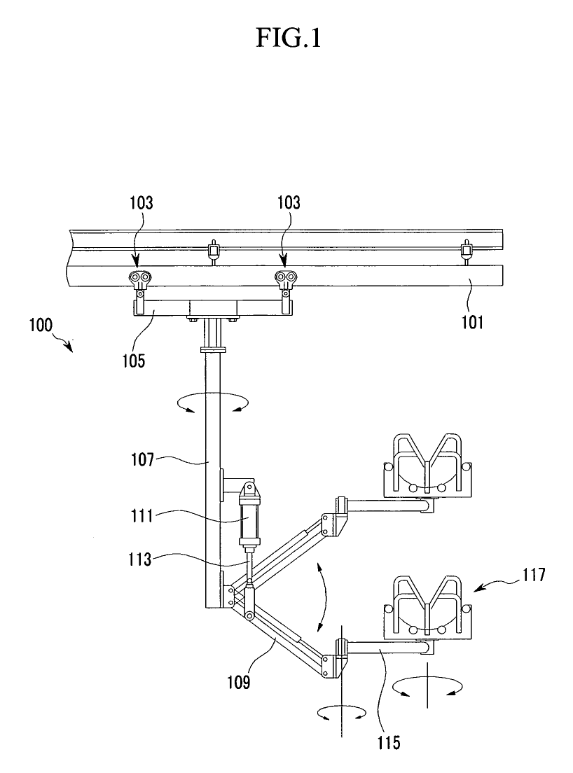

FIG. 2 is a schematic diagram showing a vehicle tire loading device according to an exemplary embodiment of the present invention.

FIG. 3 is a top plan view of a rail frame applied to a vehicle tire loading device according to an exemplary embodiment of the present invention.

FIG. 4 is a bottom view of a first operating cylinder applied to a vehicle tire loading device according to an exemplary embodiment of the present invention.

FIG. 5 is a side view of a transfer unit applied to a vehicle tire loading device according to an exemplary embodiment of the present invention.

FIG. 6 is a top plan view of a horizontal transfer unit applied to a vehicle tire loading device according to an exemplary embodiment of the present invention.

FIG. 7 is a schematic diagram showing loading processes of a tire by using a vehicle tire loading device according to an exemplary embodiment of the present invention.

### DETAILED DESCRIPTION

Hereinafter reference will now be made in detail to various embodiments of the present invention, examples of which are illustrated in the accompanying drawings and described below.

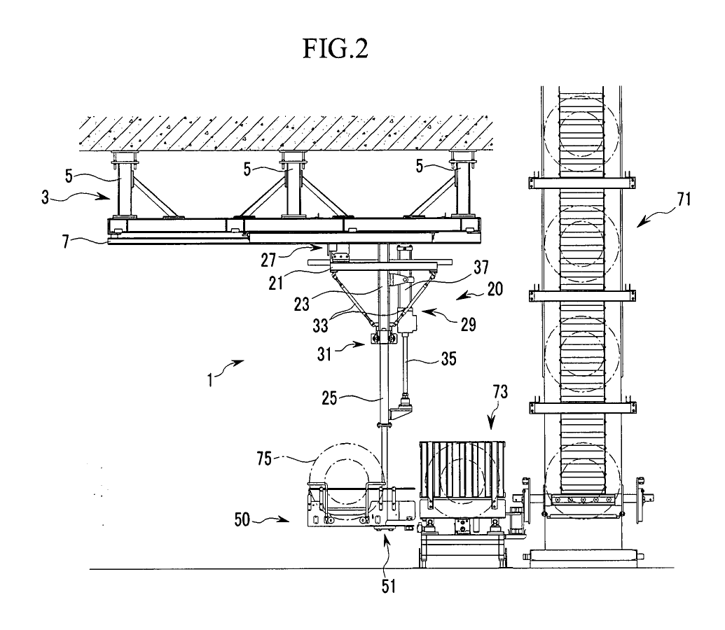

A vehicle tire loading device according to an exemplary embodiment of the present invention will be described with reference to FIGS. 2-6.

A vehicle tire loading device 1 according to an exemplary embodiment of the present invention facilitates installation of a tire 75 by automatically moving the tire 75 supplied by a traverse 73 in a tire assembly process to a mounting position of the tire in a vehicle body 80, thereby improving work efficiency and preventing work-related musculoskeletal problems.

The vehicle tire loading device 1 according to an exemplary embodiment of the present invention includes a rail frame 3, a transfer unit 20, and a tire basket 50, as shown in FIG. 2.

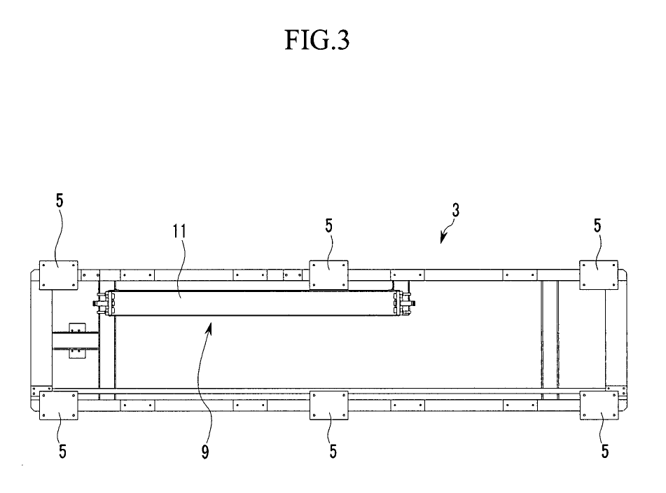

According to an exemplary embodiment of the present invention, the rail frame 3, as shown in FIG. 2 and FIG. 3, is fixedly mounted on an upper portion of a workplace by a supporter 5 in a length direction of the vehicle body 80 that is transferred on a tire mounting line. A rail 7 is formed at a lower surface of the rail frame 3. A pair of rail frames 3 is provided, and a first operating cylinder 9 is mounted between the rail frames 3.

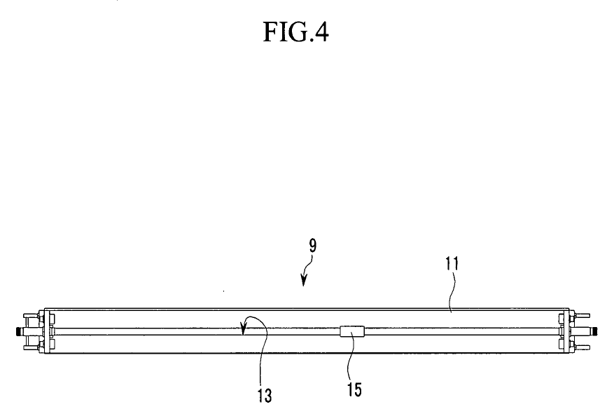

Here, the first operating cylinder 9, as shown in FIG. 4, is provided with a rail groove 13 formed along a length direction of a cylinder body 11 and a moving block 15 that moves on the rail groove 13 by hydraulic pressure supplied from a hydraulic pressure motor.

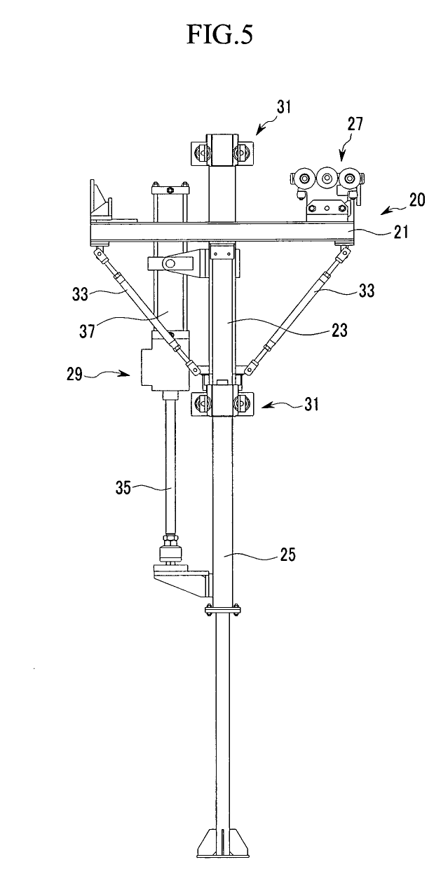

The transfer unit 20, as shown in FIG. 5, is provided with a moving frame 21, a post 23, and a moving beam 25.

The moving frame 21 is movably mounted on the rail frame 3 by roller means 27 and the first operating cylinder 9.

Here, one end of the moving frame 21 is mounted at the moving block 15 of the first operating cylinder 9, and the moving frame 21 is moved forwardly or backwardly along the length direction of the vehicle body 80 on the rail frame 3 according to movement of the moving block 15 by operating pressure.

The post 23 is mounted downwardly on the moving frame 21 in a vertical direction.

The moving beam 25 is inserted in the post 23 and is configured to be able to move upwardly and downwardly corresponding to the height of the vehicle body 80 by a vertical transfer unit 29.

Here, the post 23 has a quadrangular shape and has a hollow cross-section. Both ends of the post 23 are open such that the moving beam 25 is protruded upwardly or downwardly from the post 23 when the moving beam 25 is inserted into and moves along the post 23.

In addition, guide rollers 31 are mounted at both sides of upper and lower ends of the post 23 in order to guide the moving beam 25 when the moving beam 25 moves upwardly and downwardly.

The post 23 is supported on the moving frame 21 by a support rod 33 that has one end fixed to each lower edge portion of the moving frame 21 and the other end fixed to each corner portion of the post 23.

Meanwhile, the vertical transfer unit 29 includes a second operating cylinder 37 mounted downwardly at one side of the post 23 and having an operating rod 35. A front end of the operating rod 35 is connected to one side of the moving beam 25.

That is, the moving beam 25 is moved upwardly or downwardly in the post 23 by a reciprocating movement of the second operating cylinder 37. At this time, each guide rollers 31 guides the moving beam 25 to move upwardly or downwardly without fluctuation in the post 23.

Here, the second operating cylinder 37 moves upwardly or downwardly to a predetermined height, and the predetermined height may be changed according to a vehicle model or other factors.

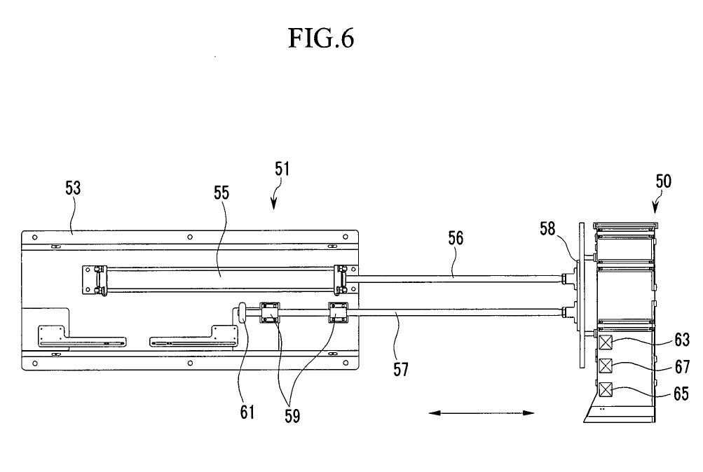

According to an exemplary embodiment of the present invention, the tire basket 50, as shown in FIG. 6, is movably mounted on a lower end of the moving beam 25 by a horizontal transfer unit 51. The tire basket 50 receives the tire 75 supplied by the traverse 73.

The horizontal transfer unit 51 includes a mounting plate 53, a third operating cylinder 55, and a guide loader 57.

The mounting plate 53 is mounted on a lower end of the moving beam 25 along a width direction of the vehicle body 80.

The third operating cylinder 55 is mounted at one side of the mounting plate 53 and has an operating rod 56. A front end of the operating rod 56 is connected to one side of the tire basket 50 by means of a mounting bracket 58.

The guide loader 57 is mounted corresponding to the third operating cylinder 55 so as to be able to slide on the other side of the mounting plate 53 by a mounting block 59. One end of the guide loader 57 is connected to the mounting bracket 58.

Here, a stopper 61 is mounted on the other end of the guide loader 57 such that the stopper abuts the mounting block 59 to prevent the guide loader 57 from being separated from the mounting plate 53.

That is, the tire basket 50 connected to the third operating cylinder 55 by the mounting bracket 58 is moved to the left or to the right in the width direction of the vehicle body 80 by reciprocating movement of the third operating cylinder 55.

At this time, the guide loader 57 guides the tire basket 50 when the tire basket 50 is moved by the reciprocating movement of the third operating cylinder 55.

Here, a forward switch 63, a backward switch 65, and a finish switch 67 are mounted at one side of the tire basket 50 such that a worker can precisely control operation of the third operating cylinder 55.

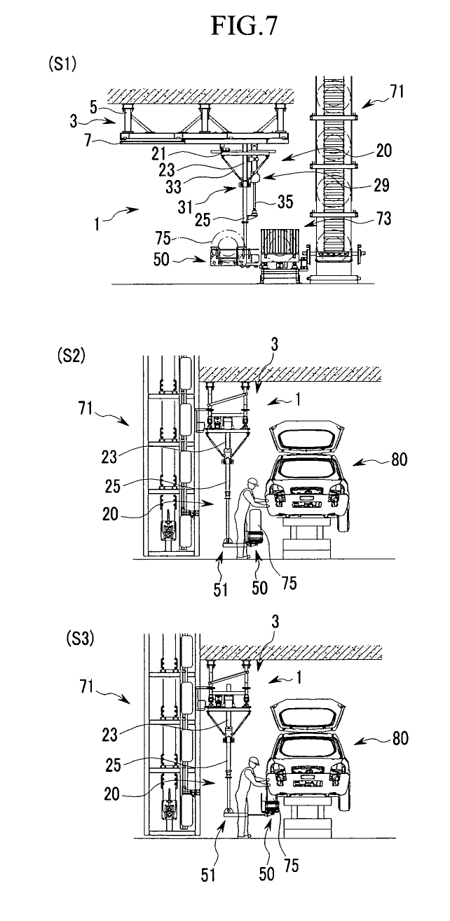

An operation of the vehicle tire loading device 1 according to an exemplary embodiment of the present invention will now be described with reference to FIG. 7.

As shown in S1 of FIG. 7, when the tire 75 is transferred to the traverse 73 in a tire assembly line by a tire conveyor 71, the transfer unit 20 moves the tire basket 50 to the traverse 73 on the rail frame 3 by operation of the first operating cylinder 9.

Then, the tire basket 50 receives the tire 75 moved from the traverse 73.

If the tire 75 arrives in the tire basket 50, the second operating cylinder 37 of the vertical transfer unit 29 is operated and raises the tire basket 50, as shown in S2 of FIG. 7.

At this time, the second operating cylinder 37 raises the tire basket 50 to a predetermined height such that the tire 75 is placed at the mounting position of the tire in the vehicle body 80.

After that, the transfer unit 20 is moved to the mounting position of the tire in the vehicle body 80 by operation of the first operating cylinder 9.

If the transfer unit is moved to the mounting position of the tire in the vehicle body 80, the third operating cylinder 55 of the vertical transfer unit 51 moves forwardly and pushes the tire basket 50 forwardly to the vehicle body 80, as shown in S3 of FIG. 7.

At this time, the worker precisely adjusts a position of the third operating cylinder 55 by means of the forward switch 63 and the backward switch 65 mounted at the tire basket 50, and thereby places the tire basket 50 at its original position and installs the tire 75 in the tire basket 50 to the vehicle body 80.

When the tire 75 is installed, the worker pushes the finish switch 67, and accordingly the second operating cylinder 37 moves downwardly so as to move the moving beam 25. In addition, the tire basket 50 moves downwardly.

If the downward movement of the tire basket 50 is completed, the third operating cylinder 55 moves backwardly and the tire basket 50 is moved to an opposite side of the vehicle body 80.

After that, the first operating cylinder 9 moves backwardly and transfers the transfer unit 20 to the traverse 73. Therefore, the tire basket 50 is moved to a position corresponding to the traverse 73 for receiving the tire 75.

By repeating the above-described process, the tires 75 transferred by the tire conveyor 71 can be mounted.

According to the present invention, since a vehicle tire may be automatically transferred to a mounting position of a vehicle body, working efficiency can be improved. In addition, since the tire is automatically raised to the mounting position (e.g., by an operation of the second operating cylinder 37), musculoskeletal problems can be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A vehicle tire loading device for transferring a tire supplied by a traverse to a tire mounting position of a vehicle body, comprising:
at least one rail frame fixedly mounted at an upper portion of a workplace by a supporter and having a rail formed at a lower surface thereof;
a transfer unit comprising a moving frame that is movably mounted on the rail frame by roller means and a first operating cylinder, a post mounted downward on the moving frame in a vertical direction, and a moving beam inserted in the post and being configured to move upwardly and downwardly by a vertical transfer unit; and
a tire basket that is movably mounted on a lower end of the moving beam by a horizontal transfer unit for receiving the tire supplied by the traverse.

2. The loading device of claim 1, wherein a pair of rail frames is provided, and the first operating cylinder is mounted between the pair of rail frames and is connected to one end of the moving frame.

3. The loading device of claim 1, wherein the post has a hollow cross section and has two ends which are open such that the moving beam can be protruded from the post upwardly or downwardly when the moving beam is inserted therein and moves along the post.

4. The loading device of claim 3, wherein guide rollers are mounted at both sides of upper and lower ends of the post such that the guide rollers guide the moving beam when the moving beam moves upwardly and downwardly.

5. The loading device of claim 1, wherein the post is supported on the moving frame by a support rod that has one end fixed to each lower edge portion of the moving frame and the other end fixed to each corner portion of the post.

6. The loading device of claim 1, wherein the vertical transfer unit comprises a second operating cylinder mounted downward at one side of the post and having an operating rod a front end of which is connected to one end of the moving beam.

7. The loading device of claim 1, wherein the horizontal transfer unit comprises:
a mounting plate mounted on a lower end of the moving beam;
a third operating cylinder mounted at one side of the mounting plate and having an operating rod a front end of which is connected to one side of the tire basket by means of a mounting bracket; and
a guide loader mounted corresponding to the third operating cylinder so as to be slid on the other side of the mounting plate by a mounting block, and having one end connected to the mounting bracket.

8. The loading device of claim 7, wherein a stopper is mounted on the other end of the guide loader for preventing the guide loader from being separated from the mounting plate.
